(19) United States
(12) Patent Application Publication
(10) Pub. No.: US 2009/0285261 A1
(43) Pub. Date: Nov. 19, 2009

(54) Integrated Circuit System Monitor

(75) Inventors: Michael J. Casey, East Twickenham (GB); Ivor G. Barber, Los Gatos, CA (US); Gregory S. Winn, Ft. Collins, CO (US); Julie L. Beatty, Campbell, CA (US); Daniel G. Deisz, McLean, VA (US)

Correspondence Address: LNG/LSI JOINT CUSTOMER;C/O LUEDEKA, NEELY & GRAHAM, P.C., P.O. BOX 1871, KNOXVILLE, TN, 37901, US

(73) Assignee: LSI CORPORATION, Milpitas, CA (US)

(21) Appl. No.: 12/122,682

(22) Filed: May 17, 2008

(51) Int. Cl. G01K 7/16; G01K 1/00; G01K 7/00

(52) U.S. Cl. 374/178; 374/100; 374/163; 374/E07.001; 374/E07.018

(57) ABSTRACT

A temperature monitoring circuit for an integrated circuit on a monolithic chip, the temperature monitoring circuit comprising a temperature sensor disposed on the monolithic chip, a system monitor disposed on the monolithic chip, and electrically conductive traces for electrically connecting the temperature sensor to the system monitor. In this manner, the temperature on the monolithic chip can be monitored by the integrated circuit itself, and appropriate action can be programmed to occur upon attaining various set points or conditions.

### FIELD

This invention relates to the field of integrated circuits. More particularly, this invention relates to a general method for measuring and capturing multiple on-chip junction temperature and Vdd values and making these values available as state variables as part of a closed loop control system.

### BACKGROUND

There is a continual desire to fabricate integrated circuits that are smaller, faster, and consume less power than earlier designs. As the term is used herein, “integrated circuit” includes devices such as those formed on monolithic semiconducting substrates, such as those formed of group IV materials like silicon or germanium, or group III-V compounds like gallium arsenide, or mixtures of such materials. The term includes all types of devices formed, such as memory and logic, and all designs of such devices, such as MOS and bipolar. The term also comprehends applications such as flat panel displays, solar cells, and charge coupled devices.

As the size of integrated circuits is reduced, so also are the gate-lengths and other critical dimensions. An undesirable side effect this size reduction is unwanted leakage of current in the transistors that are formed in the integrated circuits, which leakage generally increases the amount of power consumed by the integrated circuit. Further, the excess power consumption also raises the temperature of the semiconducting transistor junction (referred to as the junction temperature, or Tj).

An elevated junction temperature creates several problems. For example, there is a limit to the amount of power that an integrated circuit of a given size can dissipate in the form of heat. This power dissipation limit constrains the size of the integrated circuit to be no less than that which can dissipate the amount of heat that is generated at the junction. Fabricating the integrated circuit at a smaller size tends to cause a build-up of heat at the junction, which can reduce the reliability of the integrated circuit. In extreme examples, operating the integrated circuit at a higher junction temperature can result in a condition called thermal run-away, which can destroy the integrated circuit.

What is needed, therefore, is a system that overcomes problems such as those described above, at least in part.

### SUMMARY

The above and other needs are met by a temperature monitoring circuit for an integrated circuit on a monolithic chip, the temperature monitoring circuit comprising a temperature sensor disposed on the monolithic chip, a system monitor disposed on the monolithic chip, and electrically conductive traces for electrically connecting the temperature sensor to the system monitor. In this manner, the temperature on the monolithic chip can be monitored by the integrated circuit itself, and appropriate action can be programmed to occur upon attaining various set points or conditions.

In various embodiments, the temperature sensor comprises a plurality of temperature sensors. In alternate embodiments, the plurality of temperature sensors are either distributed substantially uniformly across the monolithic chip, or are designed concurrently with and incorporated into functional blocks of the integrated circuit, and the placement of the temperature sensors on the monolithic chip is wholly dependent upon the placement of the functional blocks. In alternate embodiments, the electrically conductive traces are wholly contained on the monolithic chip, or are partially formed in a package substrate to which the monolithic chip is physically attached and electrically connected.

In some embodiments the system monitor is formed in a peripheral portion of the monolithic chip. The system monitor in some embodiments is formed of transistors having a relatively thicker gate oxide in comparison to a relatively thinner gate oxide that is used in transistors formed in a core portion of the integrated circuit. In some embodiments the system monitor is formed of transistors that operate at a relatively higher voltage in comparison to a relatively lower voltage that is used in transistors formed in a core portion of the integrated circuit.

In some embodiments the system monitor includes a multiplexed analog to digital converter for sensing voltage at the temperature sensor, a current source for providing a current to the temperature sensor, a controller for at least one of controlling operation of the system monitor and manipulating voltage values sensed from the temperature sensor, a first memory for holding programming for the controller, and a second memory for holding the voltage values sensed from the temperature sensor.

In various embodiments, the temperature sensor is at least one of a temperature dependent diode junction, a bi-metallic junction, and a resistive thermal device. In some embodiments the temperature sensor is two resistors of different resistance in a series, where a current is applied at one end of the series and a voltage is sensed between the two resistors. In another embodiment the temperature sensor includes a first set of two resistors of different resistance one from another in a first series, where a first current is applied at one end of the first series and a first voltage is sensed between the two resistors of the first series, and a second set of two resistors of different resistance one from another in a second series, where a second current is applied at one end of the second series and a second voltage is sensed between the two resistors of the second series. In some embodiments the first current is equal to the second current.

### BRIEF DESCRIPTION OF THE DRAWINGS

Further advantages of the invention are apparent by reference to the detailed description when considered in conjunction with the figures, which are not to scale so as to more clearly show the details, wherein like reference numbers indicate like elements throughout the several views, and wherein:

FIG. 1 is a top plan view of a monolithic integrated circuit according to an embodiment of the present invention, having a monitor block and temperature sensors, connected by electrically conductive traces.

FIG. 2 is a top plan view of a monolithic integrated circuit according to another embodiment of the present invention, having a monitor block and temperature sensors, connected by electrically conductive traces, and functional blocks.

FIG. 3 is a functional block diagram of a monitor block according to an embodiment of the present invention.

FIG. 4 is a side cross sectional view of an integrated circuit electrically connected to a package substrate according to an embodiment of the present invention.

FIG. 5 is a circuit diagram of a temperature sensor circuit according to an embodiment of the present invention.

FIG. 6 is a circuit diagram of a temperature sensor circuit according to another embodiment of the present invention.

### DETAILED DESCRIPTION

In accordance with the various embodiments of the present invention, it is desirable to sense the junction temperature and the integrated circuit power supply voltages, and to use those as input variables to control leakage power with the integrated circuit. Many different methods of controlling leakage power can be used, such as adjusting the back bias to modify the threshold voltage, and deducting Vdd from inactive logic blocks while still retaining state voltage. In its basic embodiments, the invention provides a system monitor block within a monolithic integrated circuit, which system monitor block acts as a central resource that is connected to one or more probe points across the die.

The first section of this disclosure describes chip level planning for multiple on-die sensors and routing to a controller block. The second section of this disclosure describes in more detail the methods of estimating integrated circuit temperatures.

### Layout

With reference now to FIG. 1, there is depicted a top plan view of a monolithic integrated circuit 10 according to an embodiment of the present invention, having a monitor block 12 and temperature sensors 14, connected by electrically conductive traces 16. In the embodiment of FIG. 1, the monitor block 12 is placed in a peripheral portion of the integrated circuit 10, and the temperature sensors 14 are disposed substantially equidistant one from another across the surface of the integrated circuit 10, regardless of the placement of other elements of the integrated circuit 10, which are not depicted in FIG. 1.

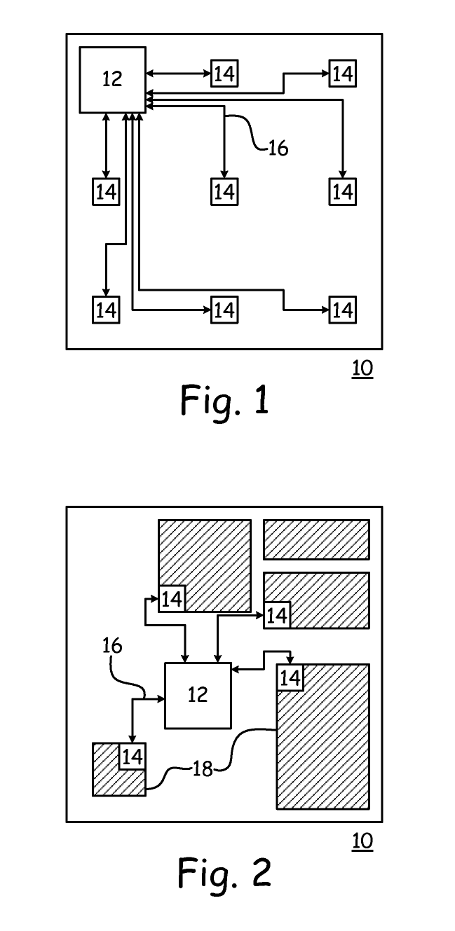

In the embodiment of FIG. 2, the monitor block 12 is placed in a more central portion of the integrated circuit 10, and the temperature sensors 14 are integrated into some of the functional blocks 18 of the integrated circuit 10, and are thus placed in locations of the integrated circuit 10 that are dependant upon the location of the functional blocks 18, rather than being evenly spaced across the surface of the integrated circuit 10. Further, in the embodiment of FIG. 2, not all of the functional blocks 18 include a temperature sensor 14.

For example, some embodiments include a temperature sensor 14 in a complex intellectual property hard macro 18. This design philosophy generally simplifies the design flow for the insertion of the temperature sensors 14, and tends to eliminate placement and routing blockages that hinder the timing closure of a given design. Instantiation of the temperature sensor 14 in a given functional block 18 is accomplished by a specialist designer, thus avoiding wide deployment of skills and expertise in placement and hook-up. Instantiation of the functional block 18 with an embedded temperature sensor 14 is done “as usual” by designers who don't require the special skills and expertise in placement. Because complex functional blocks 18 that require hardening to ensure predictability (such as high speed microprocessors, CAM memory, and large SRAM) are often high performance, these functional blocks 18 are also more likely to draw higher powers, and thus will tend to run hotter. Therefore, this embodiment ensures that these functional blocks 18 include a temperature sensor 14.

Some embodiments include more temperature sensors 14 than are depicted in FIGS. 1 and 2, and other embodiments include fewer temperature sensors 14 than are depicted in FIGS. 1 and 2. Some embodiments strive for a uniform distribution of temperature sensors 14 across the surface of the integrated circuit 10, with a large enough number of temperature sensors 14 so as to reduce and preferably eliminate local hot spots on a relatively larger chip 10. The number of such temperature sensors 14 will tend to depend in part upon the physical size of the chip 10, and the distribution of the temperature sensors 14 might depend in part upon the amount of localized heat that is generated by different functional blocks 18 in different parts of the integrated circuit 10.

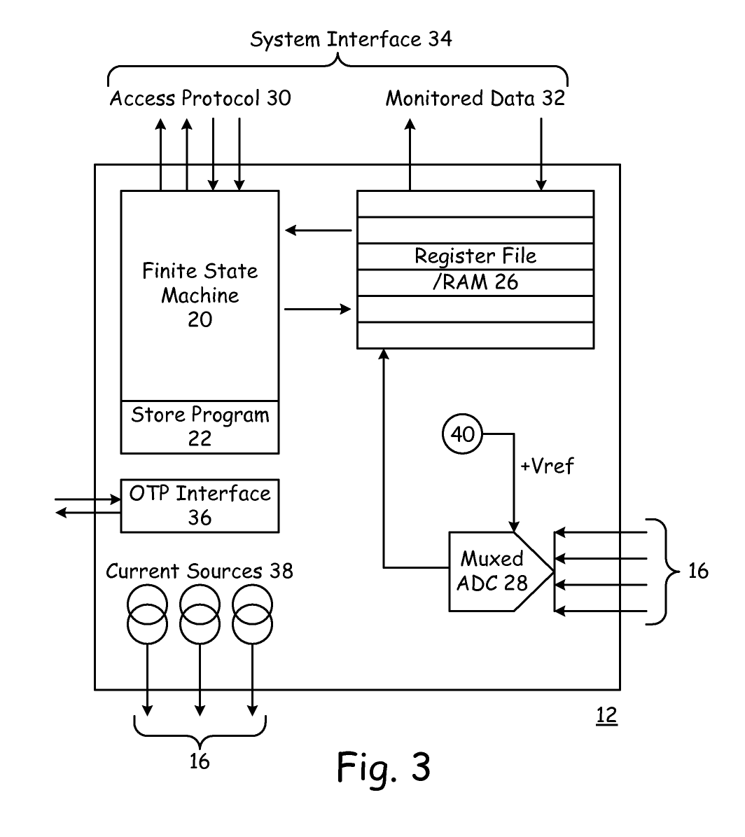

With reference now to FIG. 3, there is depicted a functional block diagram of the monitor block 12. The integrated circuit system monitor block 12 includes a multiplexed analog to digital converter 28 that makes electrical connections to the temperature sensors 14 through the traces 16. Current sources 38 also make electrical connections to the temperature sensors 14 through the traces 16, and provide the current for driving the temperature sensors 14. In some embodiments the temperature sensors 14 include a diode where the junction voltage is temperature dependent. In other embodiments the temperature sensors 14 include a thermal resistance structure, such as an RTD or a thermocouple. In some embodiments, the temperature at a given location of the integrated circuit 10 can be sensed by reading the local Vdd at a variety of different locations. In one embodiment, the muxed ADC 28 reads the temperature dependent voltages of the temperature sensors 14 and compares the voltages of the temperature sensors 14 against a reference voltage 40.

A system interface 34 is provided for access to monitored data 32 via an access protocol 30. The system interface 34 is routed off of the chip 10. The access protocol 30 in some embodiments is defined such that the monitor block 12 generates an interrupt to or supplies monitored data in response to read requests from an off-chip controller. A register file or random access memory 26 stores the monitored voltage values from the muxed ADC 28, for access across the system interface 34. The derived data values may be stored or computed. A finite state machine 20 or main control unit provides access and update methods for monitored data under the control of a stored program 22. For example, the finite state machine 20 can provide averaging of successive readings from the muxed ADC, or produce an alarm when a given voltage or other value exceeds a predefined level.

The monitor block 12 in some embodiments includes an interface 36 to an operational test program, such that system or application specific parameters may optionally be introduced, such as calibration parameters from a die level test, die identification values, alarm threshold values, and code to determine an update sampling frequency.

The monitor block 12 in one embodiment is implemented in an input/output region of the integrated circuit 10, and is designed with transistors that have relatively thicker oxide that are capable of operating at 1.5 volts or 1.8 volts, so as to be able to sense the core Vdd of 0.8 volts to 1.2 volts, while still retaining an analog voltage overhead. It is appreciated that as core voltages change in the future, similar changes in the operating voltage of the transistors of the monitor block 12 are also contemplated. Thus, the absolute values of these voltages are specific to current technologies, but the concept that the gate oxide for the monitor block 12 is generally thicker than that used in the core transistors will generally apply.

In one embodiment, whatever values—such as voltage—that sensed by the sensors 14 is converted to a temperature value in the system monitor block 12, without having to ship the data off the chip 10 to some other controller or processor. In another embodiment, any values sensed by the sensors 14 are compared to values in the system monitor block 12 that are in the native format of the sensed values—such as voltage—but which have been calibrated to temperature values, and once again the temperature at the temperature sensors 14 can be known without shipping the data off-chip to some other controller or processor. In various embodiments, the system monitor block 12 includes set points in either the program 22 or the memory 26, and the system monitor block 12 can control various operations of the integrated circuit 10, again without having to send data off-chip or receiving instructions from off-chip.

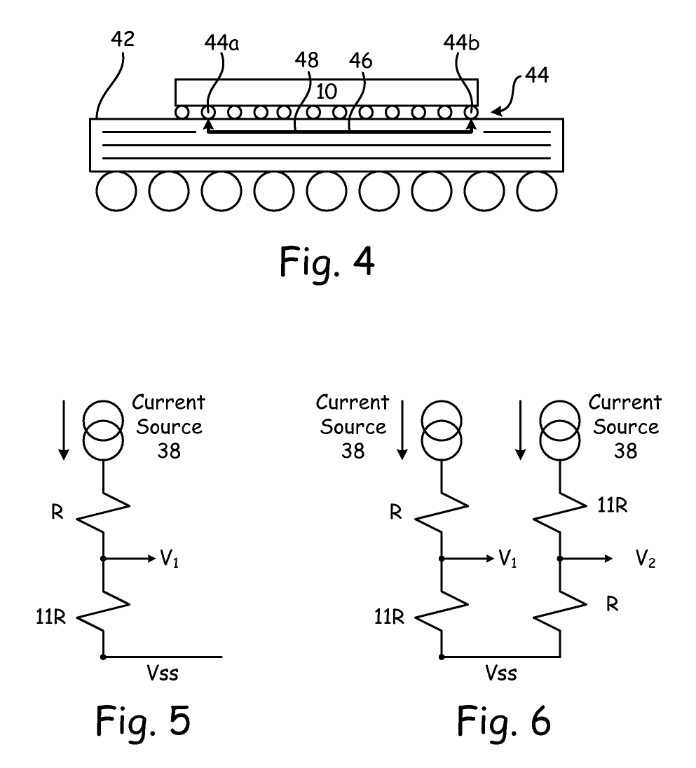

With reference now to FIG. 4, there is depicted an embodiment of the integrated circuit 10 in the form of a flip chip, that is connected to a package substrate 42 via bumps 44. In this embodiment, bump 44a is electrically connected to a temperature sensor 14, such as through a trace 16, and bump 44b is electrically connected to the monitor block 12, again such as through a trace 16. The completion of the electrical circuit between the monitor block 12 and the temperature sensor 14 is completed, in this embodiment, through the connector 46 that is disposed within one or more layers of the package substrate 42.

Routing the temperature sensor 14 to the system monitor 12 in this embodiment is accomplished by a package designer specialist, and avoids a wide deployment of skills and expertise in routing and hook-up of the temperature sensors 14. This embodiment can also eliminate on-die 10 routing blockages and matched differential resistance routes, which hinder timing closure of a design when the temperature sensor 14 routing is not on the die 10. Further, this embodiment can overcome the variability of on-chip 10 route-length resistance and differential resistance, because: (a) the few traces 16 specific to a temperature sensor 14 can be routed continuously in a single package plane in low resistance metal (without via chains); (b) routes 16 for different temperature sensors 14 can be easily matched (if necessary) in resistance to reduce or eliminate effects that might lead to differential junction temperature measurements. Because the temperature sensors 14 and the system monitor 12 are not connected on the die 10 in this embodiment, it is possible at either die test or wafer test to calibrate the temperature sensor 14 independently of the system monitor 12. This calibration data can then be used to enhance the accuracy of the measurements.

In another embodiment, if it is desirable to equalize out (1) routing resistance differences between two or more temperatures sensors 14 and the system monitor 12, or (2) routing resistance differences between two or more connections on the same temperature sensor 14 and the system monitor 12, then the width of the traces 16, such as depicted in FIGS. 1 and 2, can be adjusted. For example, if one trace 16 has a length of L, with a resistance of R per unit length, then a trace 16 that has a length of 2L can be equalized with a resistance of R/2 per unit length, and so forth. This can be accomplished by adjusting the relative widths of the various traces 16. However, in some embodiments it is more practical to make these resistance adjustments on electrical connections 46 within the package substrate 42 than it is to make the adjustments in the integrated circuit 10.

### Temperature Measurement

According to the description above, one or more temperature sensors 14, such as reference resistors, are connected to a system monitor 12, such as by using connectors 46 that are routed in package substrate 42. The system monitor 12 current source 38 forces current into the reference resistor 14. The temperature dependent resistance of the sensor 14 changes as a change in voltage across the resistance. The change in temperature of the sensor 14 can be inferred from measuring the change in voltage.

In another embodiment there can be implemented in the temperature sensor 14 two co-located resistors having different values, such as R and 11R, as depicted in FIG. 5. The change in voltage at V1 is measured, which will vary as a function of the temperature of the resistors. In another embodiment there can be implemented in the temperature sensor 14 two sets of two co-located resistors of different values, such as R and 11R, as depicted in FIG. 6. The differential voltage (V2−V1) is measured when each set of resistors is driven by matched current sources 38.

In another embodiment, one or more reference junctions between dissimilar metals are implemented using traces 46 formed in the package substrate 42. Package substrates 42 are typically manufactured using electro-chemical plating processes to deposit or remove a metal such as copper on one or more layers used in the build-up. Other metals are commonly used in the manufacture of packages, such as nickel (which may be used as a finish). The substrate 42 manufacturing process is modified in this embodiment to include a plating step on one or more layers, such that a copper-nickel junction is formed (for example—other suitable metal combinations are possible). The junction is formed in the substrate 42 at a location under the die 10, such as indicated at 48 in FIG. 4. The terminals of the junction 48 are connected to the on-chip system monitor 12, such as through the traces 46 and bumps 44.

Thermoelectric junctions can also be formed in the temperature sensors 14 on the chip 10, between two dissimilar metals that are used to form portions of the traces 16. For example, in a first step, the first terminal in the sensor 14 can be formed in a metal-1 layer with either an additive or a subtractive process. The second terminal in the sensor 14 can then be formed in a second step, by over-plating metal-1 with metal-2, again in either an additive or subtractive process. Thus, the thermoelectric junction in this embodiment is formed using dissimilar metals that are deposited on the chip 10, rather than in or on the package substrate 42. In some embodiments the junction does not form a part of the “main” circuit of the integrated circuit 10. The sensors 14 of these embodiments can be connected and routed according to any of the methods described above.

In another embodiment, the muxed ADC 28 if the system monitor 12 is used to measure a thermoelectric junction potential in the sensor 14. By measuring a temperature dependent voltage change, a change in temperature can be inferred. The voltage change is compared in one embodiment to a reference voltage, such as a pseudo cold-junction. The reference voltage and junction potential can be calibrated at a known temperature when the integrated circuit 10 is tested. The calibration data that is captured at test time can be programmed into an on-chip nonvolatile memory (such as an eFuse block) for use by the system controller 12.

The information from the system monitor 12 can be used as part of a closed loop control system for the integrated circuit 10. For example, components either inside or outside of the system monitor 12, or on or off of the chip 10, can monitor the temperature at different locations on the chip 10, and can send signals to alerts or alarms in regard to the temperature conditions of the chip 10. In this manner, the operation of the integrated circuit 10 can be adjusted if the temperature reaches a critical point, where the integrated circuit 10 could be damaged in some manner.

The foregoing description of preferred embodiments for this invention has been presented for purposes of illustration and description. It is not intended to be exhaustive or to limit the invention to the precise form disclosed. Obvious modifications or variations are possible in light of the above teachings. The embodiments are chosen and described in an effort to provide the best illustrations of the principles of the invention and its practical application, and to thereby enable one of ordinary skill in the art to utilize the invention in various embodiments and with various modifications as are suited to the particular use contemplated. All such modifications and variations are within the scope of the invention as determined by the appended claims when interpreted in accordance with the breadth to which they are fairly, legally, and equitably entitled.

What is claimed is:

1. A temperature monitoring circuit for an integrated circuit on a monolithic chip, the temperature monitoring circuit comprising:
a temperature sensor disposed on the monolithic chip,
a system monitor disposed on the monolithic chip, and
electrically conductive traces for electrically connecting the temperature sensor to the system monitor.

2. The temperature monitoring circuit of claim 1, wherein the temperature sensor comprises a plurality of temperature sensors.

3. The temperature monitoring circuit of claim 1, wherein the temperature sensor comprises a plurality of temperature sensors that are distributed substantially uniformly across the monolithic chip.

4. The temperature monitoring circuit of claim 1, wherein the temperature sensor comprises a plurality of temperature sensors that are designed concurrently with and incorporated into functional blocks of the integrated circuit, and the placement of the temperature sensors on the monolithic chip is wholly dependent upon the placement of the functional blocks.

5. The temperature monitoring circuit of claim 1, wherein the electrically conductive traces are wholly contained on the monolithic chip.

6. The temperature monitoring circuit of claim 1, wherein the electrically conductive traces are partially formed in a package substrate to which the monolithic chip is physically attached and electrically connected.

7. The temperature monitoring circuit of claim 1, wherein the system monitor is formed in a peripheral portion of the monolithic chip.

8. The temperature monitoring circuit of claim 1, wherein the system monitor is formed of transistors having a relatively thicker gate oxide in comparison to a relatively thinner gate oxide that is used in transistors formed in a core portion of the integrated circuit.

9. The temperature monitoring circuit of claim 1, wherein the system monitor is formed of transistors that operate at a relatively higher voltage in comparison to a relatively lower voltage that is used in transistors formed in a core portion of the integrated circuit.

10. The temperature monitoring circuit of claim 1, wherein the system monitor includes:
a multiplexed analog to digital converter for sensing voltage at the temperature sensor,
a current source for providing a current to the temperature sensor,
a controller for at least one of controlling operation of the system monitor and manipulating voltage values sensed from the temperature sensor,
a first memory for holding programming for the controller, and
a second memory for holding the voltage values sensed from the temperature sensor.

11. The temperature monitoring circuit of claim 1, wherein the temperature sensor is a temperature dependent diode junction.

12. The temperature monitoring circuit of claim 1, wherein the temperature sensor is a bi-metallic junction.

13. The temperature monitoring circuit of claim 1, wherein the temperature sensor is a resistive thermal device.

14. The temperature monitoring circuit of claim 1, wherein the temperature sensor is two resistors of different resistance in a series, where a current is applied at one end of the series and a voltage is sensed between the two resistors.

15. The temperature monitoring circuit of claim 1, wherein the temperature sensor comprises:
a first set of two resistors of different resistance one from another in a first series, where a first current is applied at one end of the first series and a first voltage is sensed between the two resistors of the first series, and
a second set of two resistors of different resistance one from another in a second series, where a second current is applied at one end of the second series and a second voltage is sensed between the two resistors of the second series.

16. The temperature monitoring circuit of claim 15, wherein the first current is equal to the second current.

17. A temperature monitoring circuit for an integrated circuit on a monolithic chip, the temperature monitoring circuit comprising:
a plurality of temperature sensors disposed on the monolithic chip,
a system monitor disposed on the monolithic chip, wherein the system monitor includes,
a multiplexed analog to digital converter for sensing voltage at the temperature sensors,
a current source for providing a current to the temperature sensors,
a controller for at least one of controlling operation of the system monitor and manipulating voltage values sensed from the temperature sensors,
a first memory for holding programming for the controller, and
a second memory for holding the voltage values sensed from the temperature sensors, and
electrically conductive traces for electrically connecting the temperature sensors to the system monitor.

18. The temperature monitoring circuit of claim 17, wherein the electrically conductive traces are partially formed in a package substrate to which the monolithic chip is physically attached and electrically connected.

19. A temperature monitoring circuit for an integrated circuit on a monolithic chip, the temperature monitoring circuit comprising:
a plurality of temperature sensors disposed on the monolithic chip,
a system monitor disposed on the monolithic chip, wherein the system monitor is formed in a peripheral portion of the monolithic chip and includes,
a multiplexed analog to digital converter for sensing voltage at the temperature sensors,
a current source for providing a current to the temperature sensors,
a controller for at least one of controlling operation of the system monitor and manipulating voltage values sensed from the temperature sensors,
a first memory for holding programming for the controller, and
a second memory for holding the voltage values sensed from the temperature sensors, and
electrically conductive traces for electrically connecting the temperature sensors to the system monitor,
wherein the temperature sensors are thermoelectric junctions of two dissimilar metals that are used to form portions of the traces.

20. The temperature monitoring circuit of claim 19, wherein the electrically conductive traces are partially formed in a package substrate to which the monolithic chip is physically attached and electrically connected.
